(19) United States
(12) Patent Application Publication
(10) Pub. No.: US 2026/0244266 A1
(43) Pub. Date: Aug. 20, 2026

(54) DISPLAY DEVICE AND METHOD CARRIED OUT IN A DISPLAY DEVICE

(71) Applicant: Valeo Comfort and Driving Assistance, Créteil (FR)

(72) Inventors: Ghaya Khemiri, Créteil (FR); Stephanie Dabic, Créteil (FR)

(73) Assignee: Valeo Comfort and Driving Assistance, Créteil (FR)

(21) Appl. No.: 19/142,594

(22) PCT Filed: Dec. 12, 2023
(86) PCT No.: PCT/EP2023/085320

§ 371 Date: Jun. 23, 2025

(30) Foreign Application Priority Data
Dec. 23, 2022 (FR) FR2214441

(51) Int. Cl. G06F 3/01; B60K 35/10; B60K 35/22

(52) U.S. Cl. CPC G06F 3/013; B60K 35/10; B60K 35/22; B60K 2360/741

(57) ABSTRACT

Described is a display device having a display modules, a tool for measuring a gaze direction of a user, and a module for receiving movement information of a vehicle. A control unit of the display device is configured to define a feature of an indicator according to the received movement information and to command the display module to display the indicator with the feature at a position that is dependent on the measured gaze direction.

### TECHNICAL FIELD

The present invention generally relates to the field of display systems, and notably to display systems to be used on board a vehicle.

More specifically, it relates to a display device and a method implemented in a display device.

### TECHNOLOGICAL BACKGROUND

Display devices on board vehicles, notably motor vehicles, are used increasingly frequently.

For the user, the apparent movements of the displayed objects then can be significantly different from the movements of the vehicle, notably when the display device displays an animated scene (for example, a movie or a video game), which very frequently results in motion sickness in the user.

### SUMMARY OF THE INVENTION

In this context, a display device is proposed comprising:
a display module;
a tool for measuring a gaze direction of a user;
a module for receiving movement information of a vehicle; and
a control unit configured to define at least one feature of an indicator according to the received movement information and to command the display module to display the indicator with said feature at a position that is dependent on the measured gaze direction.

Thus, the display module shows the user an indicator, a feature of which (for example, the shape or the color) depends on the movement (instantaneous or expected) of the vehicle and thus provides the user with an indication concerning this movement, which reduces the risk of motion sickness. The indicator is also displayed at a position that depends on the gaze direction of the user, which can allow, for example, the indicator to be permanently displayed in the visual field of the user and/or can allow the indicator to be displayed at a position that does not prevent the user from observing another element (object or information) displayed by the display module.

The movement information actually can be information representing instantaneous movement or information representing the expected movement of the vehicle, as explained in the following description.

For example, it is possible to anticipate the position of the indicator being located, relative to the eye of the user, in a direction forming, with the gaze direction, an angle ranging between 10° and 40°. In other conceivable embodiments, this direction can form, with the gaze direction, an angle that can vary between a first angle ranging between 4° and 20°, and a second angle ranging between 20° and 40°. The indicator thus can be seen by the user by means of their parafoveal or peripheral vision and therefore does not prevent the user (by means of their foveal vision) from observing another item (object of interest or information) displayed by the display module.

The display module can be designed to display a three-dimensional scene, for example, using stereoscopy.

The displayed indicator then can have an extension in each of the three dimensions of the three-dimensional scene.

In this case, provision can be made for the extension of the indicator displayed in an observation direction of the three-dimensional scene to be greater than the extension of the indicator displayed in a plane perpendicular to said observation direction, which results in significant freedom for defining the indicator and its possible movement.

The control unit also can be configured to command the display module to display an object or information at a distance (viewed by the user) that differs from a display distance of the indicator (as seen by the user) in the three-dimensional scene. This can allow the indicator to be displayed in a more or less visible manner with respect to the aforementioned object or information.

The control unit also can be configured to command the display module to display the indicator at a variable distance (viewed by the user) according to the movement information or other movement information received by the reception module. This allows the indicator to be displayed in a more or less visible manner according to the movements of the vehicle. For example, the indicator can be displayed at a distance (viewed by the user) that decreases with the intensity of the movements of the vehicle, such that the user sees the indicator better when the movements of the vehicle risk causing the user discomfort or even motion sickness.

The control module also can be designed to command the display module to display, in an overlapping zone of the indicator and of a displayed element, at least one pixel mixing a pixel of the indicator and a corresponding pixel of the displayed element with a variable coefficient according to the movement information or other movement information received by the reception module. The relative perception of the indicator and of the displayed element thus can vary according to the movements of the vehicle. For example, it is possible to display the indicator in a predominant manner with respect to the displayed element when the movements of the vehicle risk causing the user discomfort or even motion sickness.

The reception module can receive the movement information originating from a communication unit installed on the vehicle, for example, via a wireless link (or connection). However, as a variant, for example, when the display module forms part of an on-board system of the vehicle, the reception module can receive the information from an on-board computer or from a navigation system via a computer bus installed on the vehicle.

The movement information can be, for example, speed information of the vehicle, or acceleration information of the vehicle, or braking force information of the vehicle, or steering angle information of the vehicle.

Provision can be made for at least the display module and the measurement tool to form part of a virtual reality headset. In this case, the display device comprises means for arranging said device on the head of a user. However, as a variant, the display module can be a touch pad or, as already indicated, can form part of an on-board system of the vehicle.

The invention also proposes a method implemented in a display device comprising a display module and a tool for measuring a gaze direction of a user, said method comprising the following steps:
receiving movement information of a vehicle;
defining at least one feature of an indicator according to the received movement information;
displaying the indicator with said feature at a position depending on the measured gaze direction.

The optional features described above with respect to the display device can also apply to this method, individually or in combination.

Of course, the various features, variants and embodiments of the invention can be associated with one another in various combinations provided that they are not mutually exclusive or incompatible.

### BRIEF DESCRIPTION OF THE FIGURES

The following description with reference to the appended drawings, which are provided by way of non-limiting examples, will provide a good understanding of the content of the invention and how it can be implemented.

In the appended drawings:

FIG. 1 schematically shows a system in which the invention can be implemented;

FIG. 2 shows an example of a three-dimensional scene displayed by a display module of the system of FIG. 1;

FIG. 3 shows a side view of a display presented to the user; and

FIG. 4 shows another example of a three-dimensional scene displayed by the display module.

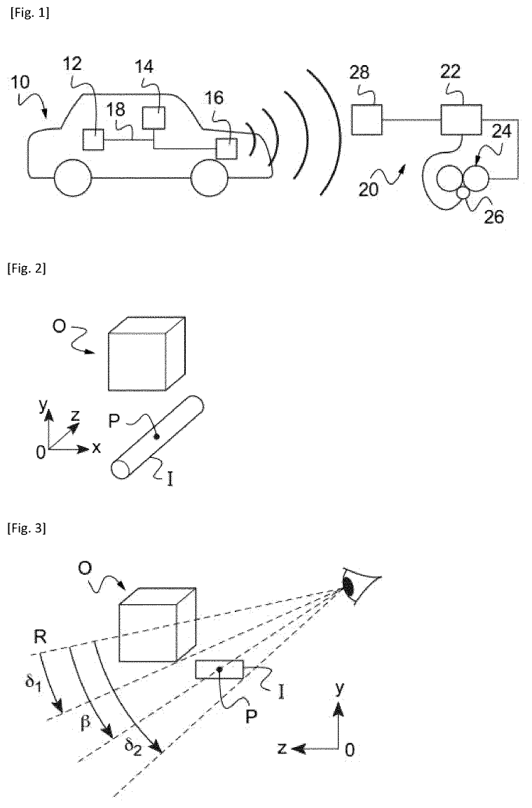

FIG. 1 schematically shows the main elements of a system in which the invention can be implemented.

Such a system comprises a vehicle 10 and a device 20 for displaying information for a user.

The vehicle 10 can be a vehicle driven by a driver or, as a variant, it can be an autonomous vehicle.

The vehicle 10 comprises an on-board computer 12, a navigation system 14, and a communication unit 16.

The on-board computer 12 provides information relating to the operation of the vehicle and in particular to the instantaneous movement of the vehicle: the on-board computer 12 provides, for example, instantaneous speed information of the vehicle, instantaneous acceleration information of the vehicle, instantaneous braking force information of the vehicle, instantaneous steering angle information of the vehicle, etc.

The instantaneous acceleration information of the vehicle can be positive or negative, and can relate to the acceleration in the direction of travel of the vehicle, or the acceleration in a direction transverse to the direction of travel, or the acceleration in a vertical direction. The on-board computer 12 can provide several items of the aforementioned instantaneous acceleration information.

The navigation system 14 is designed to determine a path of the vehicle to a destination (for example, previously entered by the user). The navigation system 14 can therefore estimate a forecast of the movement of the vehicle within a future time period with a predetermined duration (for example, 10 seconds) and can thus provide information related to the expected movement of the vehicle: the navigation system can provide, for example, expected speed information of the vehicle, expected acceleration information of the vehicle, expected braking force information of the vehicle, expected steering angle information of the vehicle, etc.

As for the information relating to the instantaneous movement, the expected acceleration information of the vehicle can be positive or negative, and can relate to the acceleration in the direction of travel of the vehicle, or the acceleration in a direction transverse to the direction of travel, or the acceleration in a vertical direction. The navigation system 14 can provide several items of the aforementioned instantaneous acceleration information.

The on-board computer 12, the navigation system 14, and the communication unit 16 are connected by a bus 18 and thus can exchange information.

The communication unit 16 thus can notably receive at least some of the information relating to the instantaneous movement of the vehicle (produced by the on-board computer 12, as indicated above) and/or at least some of the information relating to the expected movement of the vehicle (produced by the navigation system 14, as indicated above).

The communication unit 16 is designed to establish a connection (or a link) with another electronic apparatus and to exchange data with this other electronic apparatus (via the established connection). The communication unit 16 and the other electronic apparatus can form part of, for example, the same wireless local area network and can exchange data via this wireless local area network. As a variant, a direct (wired or wireless) connection can be established between the communication unit 16 and the other electronic apparatus; the communication unit 16 and the other electronic apparatus can then exchange data through this direct connection.

The communication unit 16 can thus send another electronic apparatus (such as the display device 20 described below) information relating to the instantaneous movement of the vehicle 10 and/or information relating to the expected movement of the vehicle 10.

The display device 20 is, for example, a virtual reality headset. It can be an augmented reality headset or a mixed reality headset. The display device 20 in this case comprises means for arranging said device on the head of the user. Other types of display device nevertheless can be used; for example, the display device 20 can be a touch pad.

Furthermore, an example is described herein in which the display device 20 is not equipment of the vehicle 10. However, as a variant, the display device 20 can be equipment of the vehicle 10, for example, an on-board screen in the vehicle 10.

The display device 20 comprises a control unit 22, a display module 24, a tool 26 for measuring a gaze direction of the user, and a communication module 28.

In the example described herein, the display module 24 comprises two optical assemblies (respectively intended for each eye of the user) so as to be able to show the user a three-dimensional scene using stereoscopy.

The tool 26 for measuring a gaze direction of the user is produced, for example, by using an image sensor that is located (in this case inside the virtual reality headset) such that the field of view of the image sensor covers the eyes of the user. Thus, by detecting the position of the pupils of the user within the image taken by the image sensor, the tool 26 is able to determine the gaze direction of the user (particularly in relation to the three-dimensional scene shown to the user).

The communication module 28 is designed to establish a connection (or a link) with another electronic apparatus (in this case, particularly with the communication unit 16) and to exchange data with this other electronic apparatus (via the established connection). The communication module 28 and the other electronic apparatus can form part of, for example, the same wireless local area network and can exchange data via this wireless local area network. As a variant, a direct (wired or wireless) connection can be established between the communication module 28 and the other electronic apparatus; the communication module 28 and the other electronic apparatus can then exchange data through this direct connection.

The communication module 28 can thus receive (from the vehicle 10 by means of the communication unit 16) information relating to the instantaneous movement of the vehicle 10 (produced by the on-board computer 12) and/or information relating to the expected movement of the vehicle 10 (produced by the navigation system 14).

In the aforementioned variant where the display device is equipment (for example, a screen) of the vehicle 10, the display device comprises, for example, a module for connecting to the bus 18. Such a connection module can thus form a module for receiving movement information of the vehicle 10 (originating from the on-board computer 12 or the navigation system 14).

As is schematically shown in FIG. 1, the control unit 22 is connected to the communication unit 28 (in particular in order to receive the information relating to the instantaneous movement of the vehicle 10 and/or the information relating to the expected movement of the vehicle 10), to the tool 26 (in order to receive the determined gaze direction of the user) and to the display module 24 (in order to command a three-dimensional scene to be shown to the user that comprises an indicator as well as information or an object of interest for the user, as described hereafter).

The display of an indicator I in the three-dimensional scene shown to the user by the display module 24 commanded by the control unit 22 for the purpose of notifying the user of the instantaneous or expected movement of the vehicle 10, and thereby reduce the discomfort of the user and prevent motion sickness, will be described hereafter.

In the example described herein, as shown in FIG. 2, the indicator I displayed by the display module 24 is three-dimensional. In other words, by denoting (Ox), (Oy), (Oz) as the three directions of the three-dimensional scene displayed by the display module 24, the indicator I displayed by the display module 24 extends in each of the three directions (Ox), (Oy) and (Oz).

By denoting (Oz) as the direction of observation of the user, provision is also made, in this case, for the extension of the displayed indicator I in the direction (Oz) to be greater than the extension of the displayed indicator I projecting in the plane (xOy). In other words, the displayed indicator I mainly extends in the observation direction (Oz). This can allow a realistic display to be provided and/or the user to be fully aware.

As indicated above, the control unit 22 receives the information relating to the movement (instantaneous or expected) of the vehicle 10 and can thus define one or more features of the indicator I as a function of one or more items of this information relating to the movement.

For example, the control unit 22 defines the indicator I in the form of a cylinder when the steering angle (instantaneous or expected) information is zero and in the form of a torus portion when the steering angle (instantaneous or expected) information is greater (as an absolute value) than a predefined threshold.

Furthermore, in this case, provision can be made for the curvature of the torus to be variable (in this case increasing) according to the information concerning the steering angle (instantaneous or expected).

In practice, other features of the indicator I (such as the indicator color and/or the display brightness of the indicator and/or the extension of the indicator, notably in the direction (Oz)) can be variable, respectively according to movement information (instantaneous or expected) of the vehicle 10, for example, according to the acceleration information (instantaneous or expected) of the vehicle 10 (in this case in the direction of travel of the vehicle 10).

Provision is made, in this case, for the control unit 22 to command the display module 24 to display the indicator I thus defined at a position (in the three-dimensional scene) depending on the measured gaze direction R.

For example, as illustrated in FIG. 3, the control unit 22 commands the display module 24 so that the display position P of the indicator I is located, relative to the eye of the user, in a direction D forming, with the gaze direction R, an angle β ranging between a first predetermined angle δ₁ and a second predetermined angle δ₂. For example, a first angle δ₁ is used ranging between 4° and 20° (in this case, δ₁=10°) and a second angle δ₂ is used ranging between 20° and 40° (in this case, δ₂=40°).

The indicator I is thereby located, for the user, in an angular sector distinct from the angular sector containing a displayed element (such as the object of interest O shown in FIG. 3) observed by the user and thereby located in the gaze direction R.

The indicator I is thus visible to the user (in parafoveal vision), yet without interfering with what the user observes (notably in foveal vision), irrespective of the gaze direction of the user (i.e., irrespective of the object in the three-dimensional scene observed by the user). Provision is also made, in this case, so that, when the gaze direction R of the user changes, the control unit 22 commands the display module 24 to move the position P of the indicator I so as to check the aforementioned condition, namely, that the direction D (defined by the eye of the user and the position P of the indicator I) forms, with the gaze direction R, an angle ranging between the first angle α₁ and the second angle α₂.

As seen in FIG. 2, provision is also made, in this case, for the display module 24 to display (again in this case as commanded by the control unit 22) an object of interest O (or information intended for the user) at a distance (viewed by the user) that differs from a display distance (for the user) of the indicator I in the three-dimensional scene.

Thus, in the example described herein, the projection of the position of the object O (or information) on the axis (Oz) differs from the projection of the position P of the indicator I on this same axis (Oz).

Provision also can be made for the indicator I to be displayed at a variable distance (viewed by the user) (i.e., in this case, at a variable position projected onto the axis (Oz)) according to one of the received items of movement information.

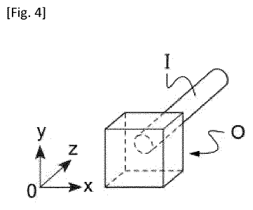

For example, when the relevant movement information meets a condition (in this case, when the absolute value of the instantaneous or expected acceleration of the vehicle is below a threshold, or when the instantaneous or expected speed is below a threshold, for example, 30 km/h), the indicator I is displayed at a first distance (as seen by the user) in the three-dimensional scene. This first distance can be greater than the display distance (for the user) of the object of interest O (or of the aforementioned information) in the three-dimensional scene, so that the indicator I will appear behind the object of interest O (or the aforementioned information), as shown in FIG. 4. The display of the indicator I thus does not trouble the user.

In other words, if z₀ denotes the coordinate of the object O along the axis (Oz) and z₁ denotes the coordinate (of the position P) of the indicator I along the axis (Oz) when the indicator I is displayed at the aforementioned first distance, then: z₀<z₁.

However, when the relevant movement information does not meet said condition (and/or meets another condition), the indicator I is displayed (for the user) at a second distance in the three-dimensional scene (with the second distance being different from the first distance and, in this case, less than the first distance). Thus, in the case described herein, when the relevant movement information does not meet the condition defined above (i.e., when the absolute value of the instantaneous or expected acceleration of the vehicle is above the aforementioned threshold), the indicator I appears in front of the object of interest O (or the aforementioned information), as shown in FIG. 2 and will be clearly visible to the user.

With z₂ denoting the coordinate of (the position P of) the indicator I when the indicator I is displayed at the aforementioned second distance, then, on the one hand, z₂<z₁, and, in this case, in addition: z₂<z₀.

It is thus possible to more clearly reveal the indicator I to the user for some predefined movements of the vehicle (in particular when these movements risk causing motion sickness).

Furthermore, as a variant or in addition to the above, it is possible to display, in an overlapping zone of the indicator and of a displayed element (object of interest or information intended for the user), at least one pixel mixing a pixel of the indicator and a corresponding pixel of the displayed element with a variable coefficient according to one of the items of received movement information.

To this end, the control unit 22 can determine a coefficient α according to the relevant movement information (for example, according to the instantaneous or expected acceleration information of the vehicle, or according to the instantaneous or expected braking force information of the vehicle). In the example described herein, the coefficient α is, for example, increasing according to the absolute value of the instantaneous or expected acceleration (or braking force) information of the vehicle.

For each pixel p of the overlapping zone of the indicator and of the displayed element (as seen in the three-dimensional scene by the user), the control unit 22 can thus determine a value Vₚ associated with this pixel p by mixing the corresponding pixel of the indicator and the corresponding pixel of the displayed element, i.e., by performing the following computation:

$${V}_{p} = α \cdot {V}_{I} + ( 1 - α ) \cdot {V}_{e}$$

where V_{I} is the value associated with the corresponding pixel in the indicator I and Vₑ is the value associated with the corresponding pixel in the displayed element.

The control unit 22 can then command the display module 24 to display the various pixels p of the overlapping zone by assigning each pixel p with the value Vₚ determined for this pixel p.

1. A display device comprising:
a display module;
a tool for measuring a gaze direction of a user;
a reception module for receiving movement information of a vehicle; and
a control unit configured to define at least one feature of an indicator according to the received movement information and to command the display module to display the indicator with the feature at a position that is dependent on the measured gaze direction.

2. The display device as claimed in claim 1, wherein the position is located, relative to an eye of the user, in a direction forming, with the gaze direction, an angle ranging between 10° and 40°.

3. The display device as claimed in claim 1, wherein the display module is designed to display a three-dimensional scene and wherein the displayed indicator has an extension in each of the three dimensions of the three-dimensional scene.

4. The display device as claimed in claim 3, wherein an extension of the indicator displayed in an observation direction of the three-dimensional scene is greater than an extension of the indicator displayed in a plane perpendicular to the observation direction.

5. The display device as claimed in claim 3, wherein the control unit is configured to command the display module to display an object or information at a distance that differs from a display distance of the indicator in the three-dimensional scene.

6. The display device as claimed in claim 3, wherein the control unit is configured to command the display module to display the indicator at a variable distance according to the movement information or other movement information received by the reception module.

7. The display device as claimed in claim 1, wherein the control module is configured to command the display module to display, in an overlapping zone of the indicator and of a displayed element, at least one pixel mixing a pixel of the indicator and a corresponding pixel of the displayed element with a variable coefficient according to the movement information or other movement information received by the reception module.

8. The display device as claimed in claim 1, wherein the reception module is designed to receive the movement information originating from a communication unit installed on the vehicle.

9. The display device as claimed in claim 1, wherein the movement information is speed information of the vehicle, or acceleration information of the vehicle, or braking force information of the vehicle, or steering angle information of the vehicle.

10. The display device as claimed in claim 1, comprising means for arranging the display device on the head of a user.

11. The display device as claimed in claim 1, wherein at least the display module and the measurement tool form part of a virtual reality headset.

12. A control unit configured to implement a method in a display device comprising a display module and a tool for measuring a gaze direction of a user, the method comprising:
receiving movement information of a vehicle;
defining at least one feature of an indicator according to the received movement information; and
controlling the display of the indicator with the feature at a position depending on the measured gaze direction.
